(19) United States
(12) Patent Application Publication
(10) Pub. No.: US 2013/0014393 A1
(43) Pub. Date: Jan. 17, 2013

(54) Bush cutter

(71) Applicant: Masao YAMASHITA, Kurobe-shi (JP)

(72) Inventor: Masao YAMASHITA, Kurobe-shi (JP)

(21) Appl. No.: 13/135,771

(22) Filed: Jul. 14, 2011

(51) Int. Cl. A01D 34/90

(52) U.S. Cl. 30/276

(57) ABSTRACT

To prevent overload and operability reduction and make operator's fatigue low in a bush cutting operation with a cutter cord in a bush cutter having a standard output, a bush cutter includes a cutting blade device at a front end of an outer pipe, a motor at a rear end of the pipe, and a driving shaft enclosed in the pipe for transmitting rotation force of the motor to the cutting blade device, a frame is attached to the outer pipe and/or the cutting blade device, and the frame has a protrusion with a front end which protrudes near a front end of a rotating cutting blade or to the front side of the front end of the blade, and extends at an angle within a range from 0 degree in parallel to 45 degrees upward with respect to a rotation face of the blade in a side view.

### BACKGROUND OF THE INVENTION

1. Field of the Invention

The present invention relates to a bush cutter.

2. Description of the Conventional Art

A portable universal bush cutter by a conventional technique is generally called a shoulder-hanging type bush cutter, and an operator works shouldering the bush cutter. The portable universal bush cutter includes a driving shaft for transmitting rotation force of a motor to a cutting blade device, and the driving shaft penetrates the inside of a rod-like outer pipe having the cutting blade device at a front end and the motor at a rear end. The bush cutter further includes a hanging tool at a part near the gravity center of a bush cutter main body, and a U-shaped handle as an operation rod at a front part of the hanging tool via a fixing tool. An operator connects the hanging tool to a shoulder-hanging band, holds both ends of the U-shaped handle, swings the bush cutter rightward and leftward, and thereby carries out bush cutting operation.

As for the portable universal bush cutter by a conventional technique which is called a knapsack-type bush cutter, a flexible shaft connected to a motor part shouldered by an operator is enclosed in a flexible tube, and connected to a driving shaft enclosed in an outer pipe connected to the flexible tube. The driving shaft transmits rotation force of a motor to a cutting blade device provided at a front end of the outer pipe.

In the knapsack-type universal bush cutter, an operator holds a loop handle and a grip attached to the outer pipe, moves the cutting blade device forward, backward, rightward and leftward, and thereby carries out a bush cutting operation.

Furthermore, in recent years, a hand pushing type bush cutter has been proposed. In the hand pushing type bush cutter, a cutting blade device is positioned at a front end, an operation handle extends to the rear side of the motor, and wheels are used as a moving means.

Reference is made to Japanese Patent Application Laid-Open No. H10-191746, Japanese Patent Application Laid-Open No. 2005-192454 and Japanese Patent Application Laid-Open No. 2006-204111

As for a bush cutter in Japanese Patent Application Laid-Open No. H10-191746, since a distance between a cutting blade device and a connection part to a wheel shaft for supporting the cutting blade device is short, vibration causing output loss of a motor is hardly generated. However, a bush cutting area is narrow. In addition, since the bush cutter is moved with two wheels on the right and left, it has been considered that the bush cutter lacks mobility and adaptability to a bush cutting environment.

As for each of bush cutters in Japanese Patent Application Laid-Open No. 2005-192454 and Japanese Patent Application Laid-Open No. 2006-204111, the distance between a cutting blade device and a connection part to a wheel shaft for supporting a cutting blade device is long. Thus, vibration causing output loss of a motor is easily generated. However, the bush cutters have an advantage that a bush cutting area is wide.

However, each of the bush cutters is moved by two wheels on the right and left. Thus, it has been considered that these bush cutters lack mobility and adaptability to a bush cutting environment, like the bush cutter in Japanese Patent Application Laid-Open No. H10-191746.

Conventionally, as the above-mentioned portable universal bush cutters, a type of rotating a metallic rotary blade at a high speed and contacting the blade to grasses or like targets to be cut them has been widely used.

However, since the metallic rotary blade rotates at high speed, the metallic rotary blade could damage an operator, or damage humans or living creatures within an operation area. Further, when the metallic rotary blade hits a thick wood or a wooden product, there is a risk that an operator or people around the operator could be seriously injured by a phenomenon called a kickback.

Further, as for the bush cutter having the metallic rotary blade, when the metallic rotary blade hits hard products hidden in bushes, e.g., stones, concretes, metallic products, glasses, and the like, during an operation, or when the metallic rotary blade hits a flower bed, a curb, a guardrail, or the like during an operation around them, a blade edge or a cutting blade main body of the metallic rotary blade could be damaged.

Furthermore, the bush cutter having the metallic rotary blade receives counterforce when the metallic rotary blade is in contact with the ground. In addition, the bush cutter has an unstable element in an operation of a cutting blade part because a high speed rotary body generating a gyro effect is arranged at a front end part of the bush cutter. Thus, the bush cutter could accidentally damage plants, which should not be damaged, in a garden such as a flow bed, or the like.

Accordingly, a cutter cord made of various materials such as a synthetic resin, or the like has been recently developed as a rotary blade for solving the aforementioned problems. In a bush cutting operation, one or more cutter cords are attached to a housing rotary body made of metal or plastic, and the housing rotary body is rotated at a high speed so as to cut plants such as grasses.

In recent years, a nylon cord type bush cutter having a function for automatically pulling out the cutter cord when the above-described cutter cord is abraded and shortened (Japanese Patent Application Laid-Open No. 7-274656), a rotary cutter (Japanese Patent Application Laid-Open No. 6-335312), and the like have been introduced and publicly used.

### SUMMARY OF THE INVENTION

### Problems to be Solved by the Invention In the conventional bush cutter mentioned above, there are the following problems when using the cutter cord as a cutting blade.

Since the cutter cord cuts grasses so as to pulverize them, load applied to the bush cutter is greater in comparison with a metallic rotary blade, and when the density of grasses is high, the bush cutter is easily overloaded. Thus, operability is extremely lowered, fatigue of an operator increases, and a body of the bush cutter, e.g., a clutch or the like, could be damaged.

Especially, in a case of a cutting method of a bush cutter being advanced in a state that a front end of a cutting blade part is placed ahead, the operability extremely decreases when the cutter cord is used.

Further, the cutting method of a bush cutter being advanced in a state that a front end of a repeating blade part is placed ahead is a very effective method in a bush cutting operation for weeds on a levee of a paddy or a field. However, when the cutter cord is used for the cutting blade part, it is almost impossible to apply the method to the bush cutter having a conventional standard output (about 0.9 to 1.1 kW).

The present invention is to solve the problems which such the conventional structures have. An objective of the present invention is to provide, at a low cost, an apparatus which does neither cause overload nor reduce operability and makes fatigue of an operator low even when the density of grasses is high, and which makes it possible to use a bush cutter having the standard output in the cutting method of the bush cutter being advanced in a state that a cutting blade part is placed ahead, in a bush cutting operation in a case of a cutter cord being used for a cutting blade part of a bush cutter.

Furthermore, another objective of the present invention is to provide, at low cost, an apparatus capable of performing a stable bush cutting operation without causing kickback, in a bush cutting operation in case of a metallic rotary blade being used in a cutting blade part of a bush cutter.

### Means for Solving the Problem

According to an aspect of a bush cutter of the present invention, the bush cutter includes a cutting blade device at a front end part of an outer pipe, a motor at a rear end part of the outer pipe, and a driving shaft enclosed in the outer pipe, where the driving shaft transmits rotation force of the motor to the cutting blade device. A frame is attached to the outer pipe and/or the cutting blade device. The frame includes an arm-shaped or frame-shaped protrusion part which protrudes to the front side of a front end part of the outer pipe. A front end position of the protrusion part protrudes to a part near a front end part of a rotating cutting blade or protrudes to the front side of the front end part of the cutting blade. In a side view, the protrusion part protrudes to extend at an angle within a range from 0 degree in parallel to 45 degrees upward with respect to a rotation face of the cutting blade.

In the bush cutter, it is preferable that the protrusion part has a bending part bent from the front end position thereof. The bending part has a circular arc-shaped or a curved shape. In the circular arc bending shape, one end is a free end. In the curved shape, both ends are fixed.

The expression of the protrusion part being the arm-shaped or frame-shaped frame, although its actions will be described in detail below, means that the shape of the protrusion part is not limited if the protrusion structure has effects to suppress vibration generated at gears in the cutting blade device and a sympathetic vibration induced by the vibration, and acts to reduce energy loss of the motor during the bush cutting operation. For example, the shape of the protrusion part can be a pipe shape or a bar shape protruding frontward in an arm shape, a frame shape protruding in a frame shape, or the like.

Further, for effectively realizing the aforementioned effectiveness, when the cutting blade rotates counterclockwise, it is preferable that the frame protrudes frontward from the right side of the outer pipe. By contrast, when the cutting blade rotates clockwise, it is preferable that the frame protrudes frontward from the left side of the outer pipe.

Particular structure examples will be described below.

In a first particular example, a bush cutter includes a cutting blade device 1 at a front part thereof, and a motor 2 at a rear part thereof. Both the cutting blade device 1 and the motor 2 are supported by an outer pipe 3. A driving shaft enclosed in the outer pipe transmits rotation force of the motor to the cutting blade device. An operation handle 4 is connected to the outer pipe. In the bush cutter, a frame 11 is provided. One end of the frame is connected to the cutting blade device or a front part of the outer pipe, and another end is connected to the operation handle. In a plan view, the shape of the frame extends frontward from the cutting blade device or the front part of the outer pipe, forms a circular arc or an angle at a position near a cutting blade front end part, extends backward at the right side of the outer pipe, and is connected to the operation handle. In a side view, the frame bends and protrudes frontward at an angle within a range from 0 degree in parallel to 45 degrees upward with respect to a rotation-side face of the cutting blade part, and then extends to the operation handle, being approximately parallel to the outer pipe or overlapping with the outer pipe.

In the bush cutter, in a plan view, the shape of the frame extends frontward from the cutting blade device or the front part of the outer pipe, is bent at a position near the cutting blade front end part, then turns to the right side of the outer pipe, and is connected to the operation handle.

For example, a state in a plan view means a state when a bush cutter is put on a flatland and viewed it from the top, as illustrated in FIG. 2. For example, a state in a side view means a state when the bush cutter is laid and viewed it from a side part as illustrated in FIG. 3. Further, the cutting blade side is expressed as a front side, the motor side is expressed as a rear side, and a right hand side of an operator who shoulders the bush cutter is expressed as a right side.

In a second particular example, the bush cutter includes a frame 11a. One end of the frame 11a is connected to the cutting blade device or the front end of the outer pipe, and another end is connected to the front part of the outer pipe. In a plan view, the shape of the frame 11a extends frontward from the cutting blade device or the front end of the outer pipe, is bent at a position around the cutting blade front end part, extends rearward at the right side of the outer pipe, then forms a circular arc or an angle, and is connected to the front part of the outer pipe. In a side view, the frame bends and protrudes frontward at an angle within a range from 0 degree in parallel 45 degrees upward with respect to the rotation-side face of the cutting blade part, and a rear part of the frame is connected to the front part of the outer pipe, being approximately parallel to the outer pipe or overlapping with the outer pipe.

In a third particular example, the bush cutter includes a frame 11b. The frame is connected to the front part of the outer pipe by a frame fixing tool 12. In a plan view, the shape of the frame extends frontward from the front part of the outer pipe, is bent at a position around the cutting blade front end part, and extends rearward at the right side of the outer pipe, and then turns and approach to one end of the frame, so that both ends of the frame are connected to the front part of the outer pipe by the frame fixing tool. In a side view, the frame bends and protrudes frontward at an angle within a range from 0 degree in parallel to 45 degrees upward with respect to the rotation-side face of the cutting blade, and a rear part of the frame extends rearward, being approximately parallel to the outer pipe or overlapping with the outer pipe.

In a fourth particular example, the bush cutter includes a frame 11c. The frame is connected to the front part of the outer pipe by a frame fixing tool 12. In a plan view, the shape of the frame extends frontward from the front part of the outer pipe, and the most front part of the frame has a circular arc-shaped which is bent to form nearly two-thirds to three-fourths of a circle around the cutting blade front end part. In a side view, the frame bends and protrudes at an angle within a range from 0 degree in parallel to 45 degrees upward with respect to the rotation-side face of the cutting blade part.

In this case, a fixing base end part of the frame 11c is positioned at the rear side of the cutting blade rear end part of the cutting blade device.

The effects achieved by the aforementioned means to solve the problem are as follows.

As for the bush cutter having the cutting blade device 1 rotating at high speed at a front end part of a long size substance, a bush cutting operation is greatly influenced by a vector of reaction which results from the receiving position and direction of reaction force received from objects to be cut with respect to the action of the cutter cord 7 or the metallic cutting blade which rotates at a high speed (the reaction from grasses or the like with respect to the action of the rotating cutter cord 7 of the cutting blade device 1).

As for the bush cutter produced by the conventional technique, the rotating direction of the cutting blade device 1 is counterclockwise rotation as viewed from the top. When an operator performs a bush cutting operation, the operator swings a cutting blade device 1 from right to left. Thus, the position of the cutter cord 7 rotating and hitting objects to be cut is indicated by the position from 9:30 to 11:30, when it is compared to a clock face and a front end is indicated by the position of 12:00. The vector of reaction is applied in the approximately upper right direction from the position near the left-side front end of the rotating cutter cord 7 of the bush cutter.

In the aforementioned state, when the bush cutter produced by the conventional technique receives the vector of reaction in the approximately upper right direction from the position near the left-side front end of the rotating cutter cord 7 of the bush cutter, the outer pipe 3 receives force in the approximately lateral direction from left to right at the front end because the cutting blade device 1 is provided at the front end part of the long size substance.

Therefore, vibration and sympathetic vibration induced by the vibration are generated at the gears in the cutting blade device 1 and the outer pipe 3. Thus, energy loss is caused, so that the output of the motor can not be fully transmitted to the bush cutting operation.

On the other hand, since the bush cutter of the present invention has the cutting blade device 1 at the front end part of the long size substance, the pipe 3 receives force in the approximately lateral direction from left to right at the front end. However, the bush cutter includes the frames 11, 11a, and 11b each having the shape which extends frontward from the cutting blade device 1 or the front end of the outer pipe 3, forms a circular arc or an angle at the position around the cutting blade front end, and is connected to the front part of the outer pipe 3 from the right side of the outer pipe 3.

With the configuration mentioned above, the strength and rigidity of the front part of the bush cutter in the direction in parallel to the cutting blade rotation are improved. In the bush cutting operation, the vibration generated at the frame pipe 3 and the gears in the cutting blade device and the sympathetic vibrations induced by the vibration can be suppressed, so that there is the effect of reducing energy loss of the motor 2 during the bush cutting operation.

Further, the frame 11c does not have an annular shape unlike the frame 11a and the frame 11b. However, the frame 11c has the effect which is equal to or more than the effect of the aforementioned structures, because, in a plan view, the front part is formed into nearly two-thirds to three-fourths of a circle, is positioned at the part around the cutting blade front end part, and has the circular arc-shaped, while the rear part is connected to the part near the front part of the outer pipe 3.

Therefore, in the present invention, it is preferable that the protrusion part has the bending part which is bent from the front end position. As for the shape of the bending part, one end can be attached to the outer pipe in a state that another end is free, or both sides of the frame-shaped protrusion part can be fixed to the outer pipe, as described in the aforementioned various examples.

Further, in an operation machine having a rotary body, when the operation machine is supported at one part, the supporting position is determined as follows. If the position is compared to a clock face and the position affecting the objects to be processed is indicated by 12:00, the supporting position is indicated approximately by 11:00 when the rotating direction is clockwise. The supporting position is indicated approximately by 13:00 when the rotating direction is counterclockwise. These positions are considered to be most preferable for processing efficiency.

A cuttable range at the time of operating the cutting blade part is 360 degrees.

However, in the cutting method of the bush cutter being advanced in the state that the cutting blade part front end is placed ahead, the position of affecting objects such as weeds or the like is indicated by a range from approximately 10:00 to 12:00, when the position is compared to a clock face and the front end is indicated by 12:00.

The standard bush cutter rotates counterclockwise. As mentioned above, in the cutting method of the bush cutter being advanced in the state that the cutting blade part front end is placed ahead, the position of affecting objects such as weeds or the like is indicated by the range from 10:00 to 12:00, when the position is compared to a clock face and the front end is indicated by 12:00. Thus, the preferable supporting position is indicated by a range from 11:00 to 13:00. The position near the cutting blade front end part (the position of 12:00) approximately corresponds to the supporting position preferable for the position of affecting the objects to be cut.

Therefore, the following structure is proposed. In a plan view, each of the frames 11, 11a and 11b has a shape which extends frontward from the cutting blade device or a part near the front part of the outer pipe, turns to the right side of the outer pipe at a position around the front end of the cutting blade with a circular arc or a single or a plurality of angles, and is connected to the handle, a shape which curves from the right side of the outer pipe and is connected to the front part of the outer pipe, or an approximately elliptic shape or an approximately sectorial shape which is connected to the front part of the outer pipe. As for the frame 11c, in a plan view, the front part is formed into nearly two-thirds to three-fourths of a circle, is positioned at a part around the cutting blade front end part, and has a circular arc-shaped, while the rear end of the frame 11c connects to a part near the front part of the outer pipe 3.

A bush cutter as the comparative example to the aforementioned examples has a front part structure having a bracing, in which one side of the bracing is connected to the rear part of the cutting blade device 1 and another side is connected to the operation handle, and having a front end shaped in a right triangle with an angle of about 15 degrees in a plan view. When the bush cutter is used in the bush cutting operation method of the bush cutter being advanced in the state that the cutting blade part is placed ahead, operability is not improved.

On the other hand, in a side view, the frames 11, 11a, 11b, and 11c have the shapes which protrude frontward at an angle from being in parallel to 45 degrees upward with respect to the rotation-side face of the cutting blade part, in order to thereby prevent that extremely high resistance, such as abrasion or the like, is caused by contacting of the frame to weeds before cut or to the ground in the bush cutting operation.

### Effect of the Invention

As mentioned above, in a bush cutting operation where a cutter cord 7 is used in a cutting blade part of a bush cutter for the bush cutting operation, the bush cutter of the present invention does neither cause overload nor reduce operability even when the density of grasses is high, and makes fatigue of an operator low. In addition, the present invention makes it possible to use a bush cutter having a standard output in a cutting method of the bush cutter being advanced in a state that a cutting blade part is placed ahead.

Furthermore, the bush cutter is capable of performing a stable bush cutting operation without causing kickback in a bush cutting operation where a metallic rotary blade is used in a cutting blade part of a bush cutter.

### BRIEF EXPLANATION OF DRAWINGS

FIG. 1 is a perspective view illustrating a first exemplary embodiment of the present invention.

FIG. 2 is a plan view illustrating the first exemplary embodiment of the present invention.

FIG. 3 is a side view illustrating the first exemplary embodiment of the present invention.

FIG. 4 is a perspective view illustrating an example in use of the first exemplary embodiment of the present invention.

FIG. 5 is a perspective view illustrating a second exemplary embodiment of the present invention.

FIG. 6 is a plan view illustrating the second exemplary embodiment of the present invention.

FIG. 7 is a side view illustrating the second exemplary embodiment of the present invention.

FIG. 8 is a perspective view illustrating an example in use of the second exemplary embodiment of the present invention.

FIG. 9 is a perspective view illustrating a third exemplary embodiment of the present invention.

FIG. 10 is a plan view illustrating the third exemplary embodiment of the present invention.

FIG. 11 is a side view illustrating the third exemplary embodiment of the present invention.

FIG. 12 is a perspective view illustrating an example in use of the third exemplary embodiment of the present invention.

FIG. 13 is a perspective view illustrating a fourth exemplary embodiment of the present invention.

FIG. 14 is a plan view illustrating the fourth exemplary embodiment of the present invention.

FIG. 15 is a side view illustrating the fourth exemplary embodiment of the present invention.

FIG. 16 is a perspective view illustrating an example in use of the fourth exemplary embodiment of the present invention.

### DETAILED DESCRIPTION OF PREFERRED EMBODIMENT

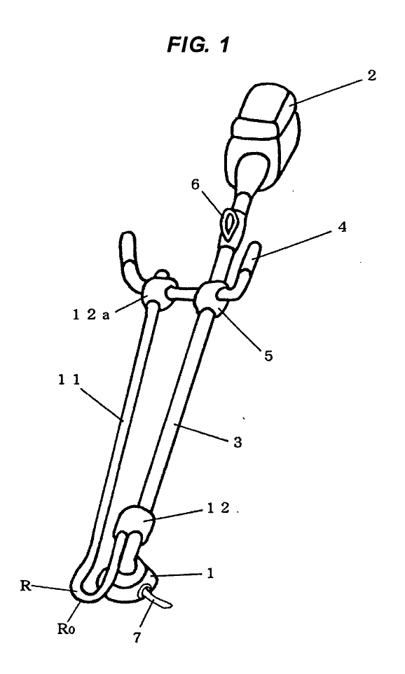

Preferred embodiments of the present invention will be described below with reference to FIGS. 1 to 16, but the present invention is not limited to these embodiments.

FIG. 1 illustrates a front part structure of a bush cutter including an operation handle 4 which is connected to an outer pipe 3 by a handle fixing tool 5. In the front part structure, the bush cutter has a frame 11. One end of the frame 11 is connected to a cutting blade device 1 or a front part of the outer pipe 3, and another end is connected to the operation handle 4 by a frame fixing tool 12. Further, the frame 11 has such a shape as to extend frontward from the cutting blade device 1, turn to the right side of the outer pipe 3 by forming a circular arc at a position around a front end of a cutter cord 7, then extend to the operation handle 4, and be fixed to the operation handle 4 by a frame fixing tool 12a.

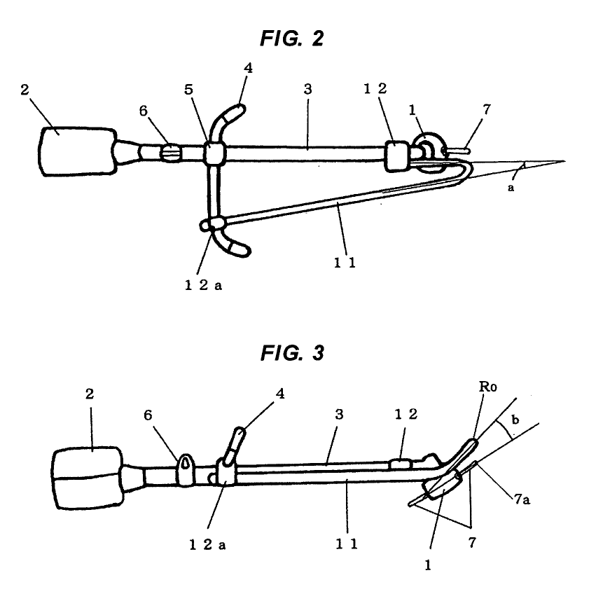

In FIG. 2, in a plan view, the frame 11 is fixed to the front part of the outer pipe 3 by the frame fixing tool 12, then extends frontward, turns to the right side of the outer pipe 3, by forming the circular arc at the position around the front end of the cutter cord 7, at a frame plane bending angle a within a range from 0 degree, which is parallel, to 45 degrees, then extends to the operation handle 4, and is connected to the operation handle 4 by the frame fixing tool 12a.

Further, it is preferable that a shape of a protrusion part R bent at the position around a front end 7a of the cutter cord 7 is a circular arc or angular curved shape.

Furthermore, a front end Ro of the protrusion part R can be positioned near the front end 7a of the cutter cord 7 or positioned at the front side of the front end 7a of the cutter cord 7.

This configuration is the same for all of the following examples.

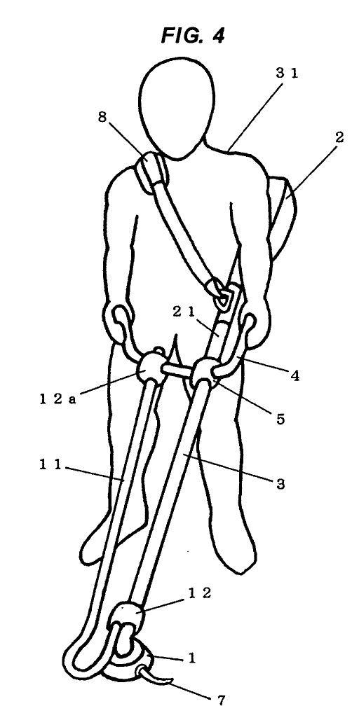

In FIG. 3, in a side view, the frame 11 protrudes frontward at a frame side-face bending angle b within a range from 0 degree in parallel 45 degrees upward with respect to the rotation-side face of the cutter cord 7 of the cutting blade device 1. Then extends rearward in a state of being approximately parallel to the outer pipe 3 or overlapping with the outer pipe 3, and is connected by the frame fixing tool 12a.

FIG. 4 illustrates, as an example in use of the first exemplary embodiment of the present invention, a state that an operator 31 uses a shoulder-hanging type bush cutter 21 having the frame 11 at the front part of the bush cutter.

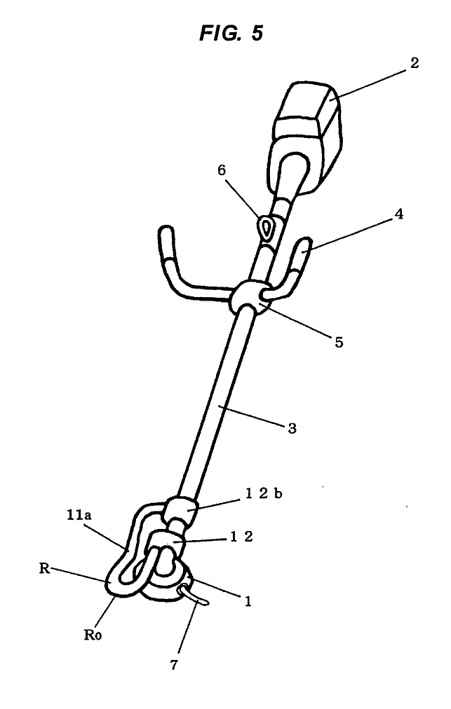

FIG. 5 illustrates a front part structure of a bush cutter including the operation handle 4 connected to the outer pipe 3 by a handle fixing tool 5. In the structure, the bush cutter has a frame 11a provided to have such a shape that one end of the frame 11a is connected to the front end of the outer pipe 3 by the frame fixing tool 12, and another end is connected to the front part of the outer pipe 3 by the frame fixing tool 12b. Further, the frame 11a extends frontward from the cutting blade device 1, extends to the right side of the outer pipe 3 by forming the circular arc near the front end of the cutter cord 7, and then the frame 11a bends again, and is connected to the front part of the outer pipe 3.

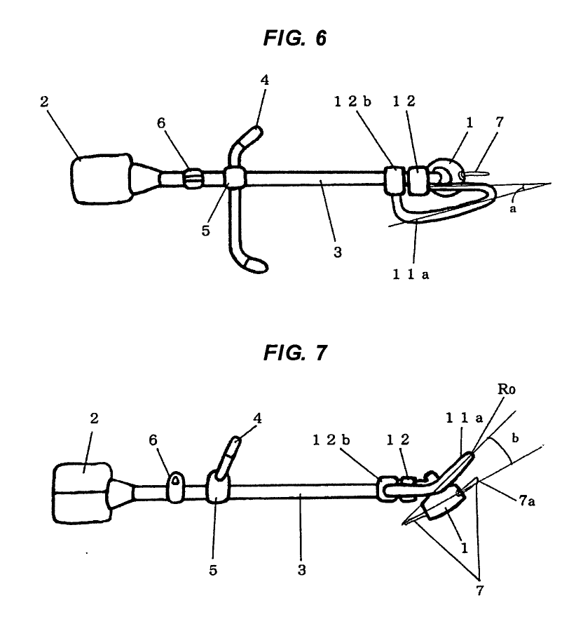

In FIG. 6, in a plan view, the frame 11a is connected to the front end of the outer pipe 3 by the frame fixing tool 12, then extends frontward, extends rearward at the right side of the outer pipe by forming the circular arc at a position beyond the front end of the cutter cord 7, then bends and is connected to the front part of the outer pipe 3 by the frame fixing tool 12b.

Further, the shape of bend at the position around the front end of the cutter cord 7 can be circular arc and/or angular.

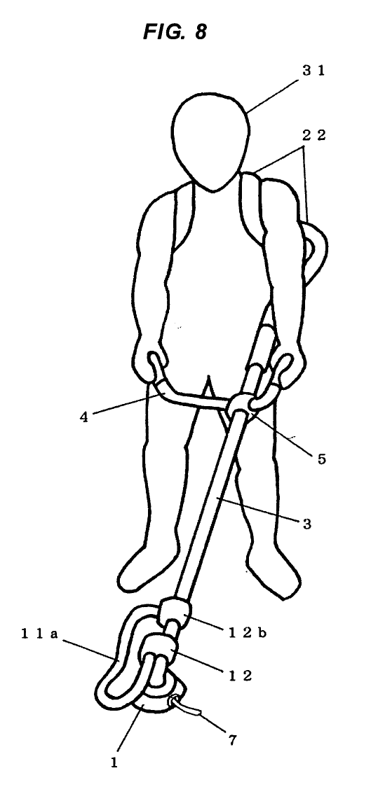

In FIG. 7, in a side view, the frame 11a protrudes frontward at a frame side-face bending angle b within a range from 0 degree in parallel to 45 degrees upward with respect to the rotation-side face of a cutter cord 7 of the cutting blade device, then extends in a state of being in parallel to the outer pipe 3 or overlapping with the outer pipe 3, and is connected to the front part of the outer pipe 3 by the frame fixing tool 12b.

FIG. 8 illustrates, as an example in use of the second exemplary embodiment of the present invention, a state that an operator 31 uses a knapsack-type bush cutter 22 having the frame 11a at the front part of the bush cutter.

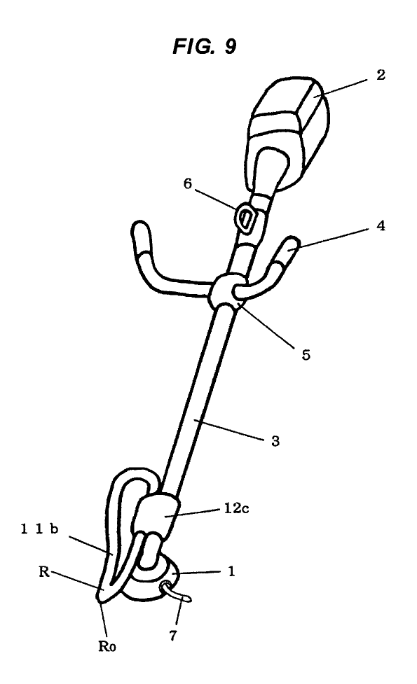

FIG. 9 illustrates an example in use of the third exemplary embodiment of the present invention in which the frame lib is fixed to the front part of the outer pipe 3 by the frame fixing tool 12c.

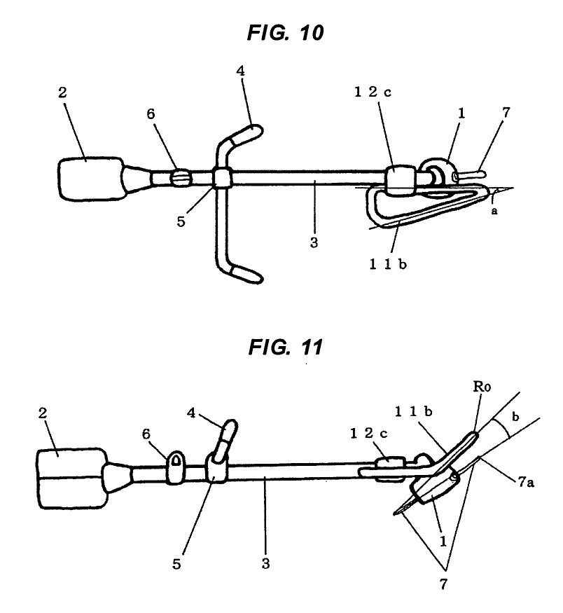

In FIG. 10, in a plan view, the shape of the frame 11b extends frontward from the front part of the outer pipe 3, forms an angle at the position around the cutting blade front end part, extends rearward at the right side of the outer pipe, then bends in circular arc shape, and approaches to an end of the frame 11b, and both ends of the frame 11b are connected to the front part of the outer pipe 3 by the frame fixing tool 12c.

Further, the shape bent at the position around the front end of the cutter cord 7 can be circular arc and/or angular.

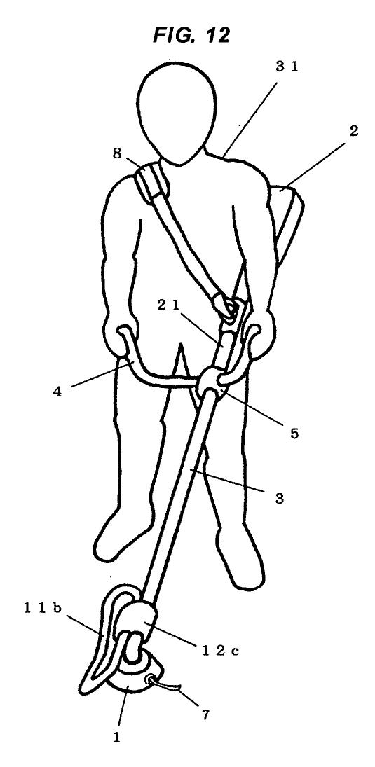

In FIG. 11, in a side view, the front part of the frame 11b protrudes frontward at a frame side face bending angle b within a range from 0 degree in parallel to 45 degrees upward with respect to the rotation face of the cutter cord 7 of the cutting blade device. The rear part of the frame is approximately parallel to the outer pipe 3 or overlaps with the outer pipe 3.

FIG. 12 illustrates, as an example in use of the third exemplary embodiment of the present invention, a state that an operator 31 uses a shoulder-hanging type bush cutter 21 having the frame 11b at the front part of the bush cutter.

The frame plane bending angle a of the frame 11 is, for example, 0 degree (parallel) to 45 degrees.

A plane curving radius of the front part circular arc of the frames 11, 11a and 11b is, for example, 30 mm to 80 mm.

The frame side-face bending angle b of the frames 11 and 11a is from parallel to 45 degrees.

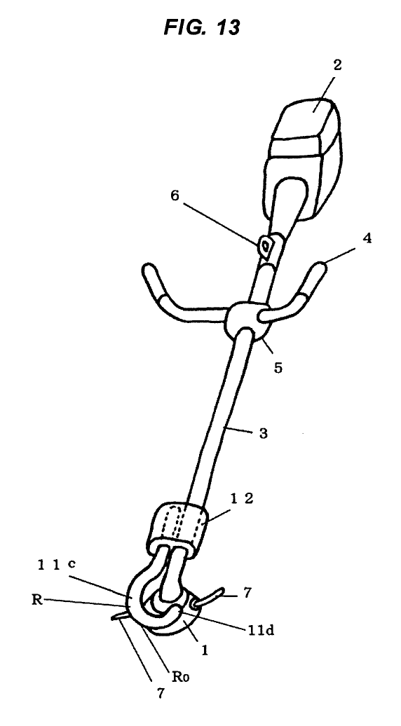

FIG. 13 illustrates an example of the fourth exemplary embodiment of the present invention in which the frame 11b is fixed to the front part of the outer pipe 3 by the frame fixing tool 12c.

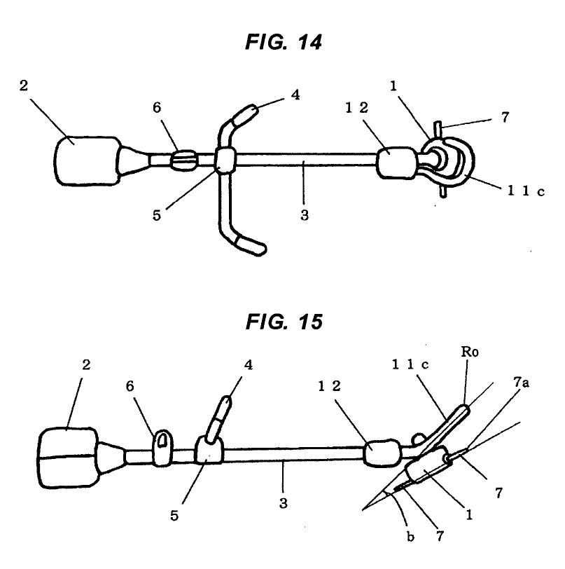

In FIG. 14, in a plan view, the shape of the frame 11c is a circular arc-shaped, which extends frontward from the front part of the outer pipe 3 and is formed into nearly two-thirds and three-fourths of a circle around the cutting blade front end part.

The present exemplary embodiment is an example in which the rear end side as one end of the frame 11c is fixed on the front right side of the outer pipe 3 by the fixing tool 12c. However, the protrusion part R is bent leftward, and another end of the frame 11c is a free end 11d.

In addition, an example in which the frame 11c is attached to a housing of the cutting blade device can be considered.

In FIG. 15, in a side view, the front part of the frame 11c protrudes frontward at the frame side-face bending angle b within a range from 0 degree in parallel to 45 degrees upward with respect to the rotation face of the cutter cord 7 of the cutting blade device. The rear part of the frame is approximately parallel to the outer pipe 3 or overlaps with the outer pipe 3.

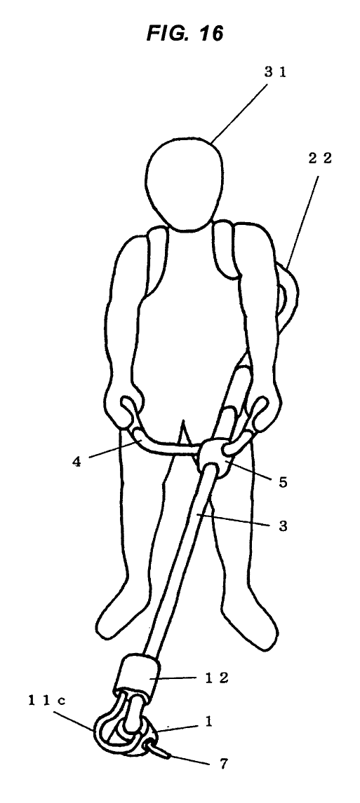

FIG. 16 illustrates, as an example in use of the fourth exemplary embodiment of the present invention, a state that an operator 31 uses a knapsack type bush cutter 22 having the frame 11c at the front part of the bush cutter.

The longitudinal sizes of the frame 11a, 11b and 11c are, for example, 200 mm to 600 mm. The lateral sizes are, for example, 100 mm to 300 mm.

The aforementioned effects can be obtained even in a hand pushing type bush cutter including the frame 11 and the frame fixing tools 12 and 12a, the frame 11a and the frame fixing tools 12 and 12b, the frame 11b and the frame fixing tool 12b, or the frame 11c and the frame fixing tool 12, which are all used in the present invention.

As materials of the frames 11, 11a, 11b and 11c, light alloys such as aluminum, titanium, and the like, reinforced plastics such as FRP, and the like, carbon fibers or the like can be used.

What is claimed is:

1. A bush cutter comprising:
a cutting blade device at a front end part of an outer pipe;
a motor at a rear end part of the outer pipe; and
a driving shaft enclosed in said outer pipe to transmit rotation force of the motor to the cutting blade device, wherein the rear end part side of a frame, which bends in a circular arc shape, is attached to the front end part side of said outer pipe,
wherein said frame protrudes frontward from the right side of the outer pipe to form a protrusion part, in case that a cutting blade rotates counterclockwise, wherein said frame protrudes frontward from the left side of the outer pipe to form a protrusion part, in case that the cutting blade rotates clockwise,
wherein, in a plan view, said protrusion part is formed to be a free end bending in a circular arc shape corresponding to two-thirds to three-fourths of a circle toward the rotational direction side of the cutting blade around a cutting blade front end part, and
wherein, in a side view, the protrusion part protrudes to extend at an angle within a range from 10 to 45 degrees upward with respect to a rotation face of the cutting blade.
